(19) United States
(12) Patent Application Publication
(10) Pub. No.: US 2010/0014133 A1
(43) Pub. Date: Jan. 21, 2010

(54) METHOD TO MODIFY AND APPLY EDGE SEAL MATERIALS IN LAMINATED MEDIA

(75) Inventors: Peter Whiteside, Longmont, CO (US); Andrew A. Lucas, Lyons, CO (US)

Correspondence Address: Vedder Price, PC, 875 15th Street, NW, Suite 725, Washington, DC, 20005, US

(73) Assignee: INPHASE TECHNOLOGIES, INC., Longmont, CO (US)

(21) Appl. No.: 12/506,284

(22) Filed: Jul. 21, 2009

Related U.S. Application Data
(60) Provisional application No. 61/082,328, filed on Jul. 21, 2008.

(51) Int. Cl. G03H 1/02

(52) U.S. Cl. 359/3

(57) ABSTRACT

An article with a pair of substrates made from a thermoplastic and each having an outer edge; a holographic storage medium positioned between the substrates such that the holographic storage medium has an exposed outer edge area proximate the outer edges of the substrates; and an environmental barrier seal protecting the exposed outer edge area; wherein (1) the environmental barrier seal includes a temperature-responsive stress-relieving structure; or (2) the substrates, holographic storage medium, and environmental barrier seal have materials with compatible coefficients of thermal expansion. Also a process which forms a temperature-responsive stress-relieving structure in a portion of the environmental barrier seal for relieving such temperature induced stress.

### CROSS-REFERENCE TO RELATED APPLICATIONS

This application makes reference to and claims the benefit of the following co-pending U.S. Provisional Patent Application No. 61/082,328 filed Jul. 21, 2008. The entire disclosure and contents of the foregoing Provisional Application is hereby incorporated by reference. This application also makes reference to the following U.S. patent applications: U.S. Provisional Patent Application No. 61/060,890, entitled “A SYSTEM AND DEVICES FOR IMPROVING EXTERNAL CAVITY DIODE LASERS USING WAVELENGTH AND MODE SENSORS AND COMPACT OPTICAL PATHS,” filed Jun. 12, 2008; U.S. Provisional Patent Application No. 61/054,613, entitled “A METHOD FOR COMPENSATING FOR THERMAL EFFECTS OF A PHOTOPOLYMER BY USING ADAPTIVE ENERGY CONTROL,” filed May 20, 2008; U.S. Provisional Patent Application No. 61/028,628, entitled “SERVO FOR HOLOGRAPHIC DATA STORAGE,” filed Feb. 14, 2008; U.S. Provisional Patent Application No. 60/980,604, entitled “LAYOUT METHOD FOR MULTIPLEXED HOLOGRAMS,” filed Oct. 17, 2007; U.S. Provisional Patent Application No. 60/855,754, entitled “EMULATION OF DISSIMILAR REMOVABLE MEDIUM STORAGE DEVICE TYPES ASSISTED BY INFORMATION EMBEDDED IN THE LOGICAL FORMAT,” filed Sep. 1, 2006; U.S. patent application Ser. No. 11/849,658, entitled “EMULATION OF DISSIMILAR REMOVABLE MEDIUM STORAGE DEVICE TYPES ASSISTED BY INFORMATION EMBEDDED IN THE LOGICAL FORMAT,” filed Sep. 4, 2007; U.S. Provisional Patent Application No. 60/831,692, entitled “EXTERNAL CAVITY DIODE LASER COLLIMATION GROUP ADJUSTMENT” filed Jul. 19, 2006; U.S. patent application Ser. No. 11/826,517, entitled “COLLIMATION LENS GROUP ADJUSTMENT FOR LASER SYSTEM” filed Jul. 16, 2007, now U.S. Pat. No. 7,495,838, issued Feb. 24, 2009; U.S. Provisional Patent Application No. 60/802,530, entitled “HIGH-SPEED ELECTROMECHANICAL SHUTTER” filed May 25, 2006; U.S. patent application Ser. No. 11/752,804, entitled “HIGH-SPEED ELECTROMECHANICAL SHUTTER” filed May 25, 2007; U.S. Provisional Patent Application No. 60/793,322, entitled “METHOD FOR DESIGNING INDEX CONTRASTING MONOMERS” filed Apr. 20, 2006; U.S. Provisional patent application Ser. No. 11/738,394, entitled “INDEX CONTRASTING-PHOTOACTIVE POLYMERIZABLE MATERIALS, AND ARTICLES AND METHODS USING SAME” filed Apr. 20, 2007; U.S. Provisional Patent Application No. 60/780,354, entitled “EXTERNAL CAVITY LASER” filed Mar. 9, 2006; U.S. patent application Ser. No. 11/716,002, entitled “EXTERNAL CAVITY LASER” filed Mar. 9, 2007; U.S. Provisional Patent Application No. 60/779,444, entitled “METHOD FOR DETERMINING MEDIA ORIENTATION AND REQUIRED TEMPERATURE COMPENSATION IN PAGE-BASED HOLOGRAPHIC DATA STORAGE SYSTEMS USING DATA PAGE BRAGG DETUNING MEASUREMENTS” filed Mar. 7, 2006; U.S. patent application Ser. No. 11/714,125, entitled “METHOD FOR DETERMINING MEDIA ORIENTATION AND REQUIRED TEMPERATURE COMPENSATION IN PAGE-BASED HOLOGRAPHIC DATA STORAGE SYSTEMS USING DATA PAGE BRAGG DETUNING MEASUREMENTS” filed Mar. 6, 2007; U.S. Provisional Patent Application No. 60/778,935, entitled “MINIATURE FLEXURE BASED SCANNERS FOR ANGLE MULTIPLEXING” filed Mar. 6, 2006; U.S. Provisional Patent Application No. 60/780,848, entitled “MINIATURE FLEXURE BASED SCANNERS FOR ANGLE MULTIPLEXING” filed Mar. 10, 2006; U.S. Provisional Patent Application No. 60/756,556, entitled “EXTERNAL CAVITY LASER WITH A TUNABLE HOLOGRAPHIC ELEMENT” filed Jan. 6, 2006; U.S. patent application Ser. No. 11/649,801, entitled “AN EXTERNAL CAVITY LASER WITH A TUNABLE HOLOGRAPHIC ELEMENT” filed Jan. 5, 2007; U.S. Provisional Patent Application No. 60/738,597, entitled “METHOD FOR HOLOGRAPHIC DATA RETRIEVAL BY QUADRATURE HOMODYNE DETECTION” filed Nov. 22, 2005; U.S. patent application Ser. No. 11/562,533, entitled “METHOD FOR HOLOGRAPHIC DATA RETRIEVAL BY QUADRATURE HOMODYNE DETECTION” filed Nov. 22, 2006; U.S. patent application Ser. No. 11/402,837, entitled “ARTICLE COMPRISING HOLOGRAPHIC MEDIUM BETWEEN SUBSTRATES HAVING ENVIRONMENTAL BARRIER SEAL AND PROCESS FOR PREPARING SAME” filed Dec. 2, 2005; U.S. patent application Ser. No. 11/291,845, entitled “ARTICLE COMPRISING HOLOGRAPHIC MEDIUM BETWEEN SUBSTRATES HAVING ENVIRONMENTAL BARRIER SEAL AND PROCESS FOR PREPARING SAME” filed Dec. 2, 2005; U.S. Provisional Patent Application No. 60/728,768, entitled “METHOD AND SYSTEM FOR INCREASING HOLOGRAPHIC DATA STORAGE CAPACITY USING IRRADIANCE-TAILORING ELEMENT” filed Oct. 21, 2005; U.S. patent application Ser. No. 11/319,425, entitled “METHOD AND SYSTEM FOR INCREASING HOLOGRAPHIC DATA STORAGE CAPACITY USING IRRADIANCE-TAILORING ELEMENT” filed Dec. 27, 2005; U.S. Provisional Application No. 60/684,531, entitled “METHODS FOR MAKING A HOLOGRAPHIC STORAGE DRIVE SMALLER, CHEAPER, MORE ROBUST AND WITH IMPROVED PERFORMANCE” filed May 26, 2005; U.S. patent application Ser. No. 11/440,368, entitled “REPLACEMENT AND ALIGNMENT OF LASER” filed May 25, 2006; U.S. patent application Ser. No. 11/440,369, entitled “HOLOGRAPHIC DRIVE HEAD ALIGNMENTS” filed May 25, 2006; U.S. patent application Ser. No. 11/440,365, entitled “LASER MODE STABILIZATION USING AN ETALON” filed May 25, 2006; U.S. patent application Ser. No. 11/440,366, entitled “ERASING HOLOGRAPHIC MEDIA” filed May 25, 2006; U.S. patent application Ser. No. 11/440,367, entitled “POST-CURING OF HOLOGRAPHIC MEDIA” filed May 25, 2006; U.S. patent application Ser. No. 11/440,371, entitled “SENSING ANGULAR ORIENTATION OF HOLOGRAPHIC MEDIA IN A HOLOGRAPHIC MEMORY SYSTEM” filed May 25, 2006; U.S. patent application Ser. No. 11/440,372, entitled “SENSING ABSOLUTE POSITION OF AN ENCODED OBJECT” filed May 25, 2006; U.S. patent application Ser. No. 11/440,357, entitled “CONTROLLING THE TRANSMISSION AMPLITUDE PROFILE OF A COHERENT LIGHT BEAM IN A HOLOGRAPHIC MEMORY SYSTEM” filed May 25, 2006; U.S. patent application Ser. No. 11/440,358, entitled “OPTICAL DELAY LINE IN HOLOGRAPHIC DRIVE” filed May 25, 2006. U.S. application Ser. No. 11/440,359, entitled “HOLOGRAPHIC DRIVE HEAD AND COMPONENT ALIGNMENT” filed May 25, 2006; U.S. patent application Ser. No. 11/440,448, entitled “IMPROVED OPERATIONAL MODE PERFORMANCE OF A HOLOGRAPHIC MEMORY SYSTEM” filed May 25, 2006; U.S. patent application Ser. No. 11/440,447, entitled “PHASE CONJUGATE RECONSTRUCTION OF A HOLOGRAM” filed May 25, 2006; U.S. patent application Ser. No. 11/440,446, entitled “METHODS AND SYSTEMS FOR LASER MODE STABILIZATION” filed May 25, 2006, now U.S. Pat. No. 7,379,571, issued Jul. 8, 2008; U.S. patent application Ser. No. 11/440,370, entitled “ILLUMINATIVE TREATMENT OF HOLOGRAPHIC MEDIA” filed May 25, 2006; U.S. patent application Ser. No. 11/447,033, entitled “LOADING AND UNLOADING MECHANISM FOR DATA STORAGE CARTRIDGE AND DATA DRIVE” filed Jun. 6, 2006; U.S. patent application Ser. No. 11/283,864, entitled “DATA STORAGE CARTRIDGE LOADING AND UNLOADING MECHANISM, DRIVE DOOR MECHANISM AND DATA DRIVE” filed Nov. 22, 2006; U.S. patent application Ser. No. 11/237,883, entitled “LOW CTE MEDIA FOR HOLOGRAPHIC RECORDING BY PROVIDING A SLIP LAYER BETWEEN THE MEDIA AND ITS SUBSTRATES” filed Sep. 29, 2005; U.S. patent application Ser. No. 11/261,840, entitled “SHORT STACK RECORDING IN HOLOGRAPHIC MEMORY SYSTEMS” filed Dec. 2, 2005; U.S. patent application Ser. No. 11/067,010, entitled “HIGH FIDELITY HOLOGRAM DEVELOPMENT VIA CONTROLLED POLYMERIZATION” filed Feb. 28, 2005; U.S. Provisional Patent Application No. 60/576,381, entitled “METHOD FOR ORGANIZING AND PROTECTING DATA STORED ON HOLOGRAPHIC MEDIA BY USING ERROR CONTROL AND CORRECTION TECHNIQUES AND NEW DATA ORGANIZATION STRUCTURES” filed Jun. 3, 2004; U.S. patent application Ser. No. 11/139,806, entitled “DATA PROTECTION SYSTEM” filed May 31, 2005; U.S. patent application Ser. No. 11/140,151, entitled “MULTI-LEVEL FORMAT FOR INFORMATION STORAGE” filed May 31, 2005; U.S. patent application Ser. No. 10/866,823, entitled “THERMOPLASTIC HOLOGRAPHIC MEDIA” filed Jun. 15, 2004. The entire disclosure and contents of the above applications are hereby incorporated by reference.

### FIELD OF THE INVENTION

The present invention generally relates to environmental barrier seals for protecting the exposed outer edge area of holographic storage medium and for relieving temperature-induced stress in the edge area of the medium. The present invention also generally relates to a process which forms a structure in a portion of the seal for relieving such temperature-induced stress.

### BACKGROUND

Developers of information storage devices and methods continue to seek increased storage capacity. As part of this development, so-called page-wise memory systems, in particular holographic systems, have been suggested as alternatives to conventional memory devices. Page-wise systems involve the storage and readout of an entire two-dimensional representation, e.g. a page of data. Typically, recording light passes through a two-dimensional array of dark and transparent areas representing data, and the holographic system stores, in three dimensions, holographic representations of the pages as patterns of varying refractive index imprinted into a storage medium. Holographic systems are discussed generally in Psaltis et al., “Holographic Memories,” Scientific American, November 1995.

The capabilities of typical holographic recording systems are determined in part by the storage medium. One type of holographic recording media used recently for such systems are photosensitive polymer films. See, e.g., Smothers et al., “Photopolymers for Holography,” SPIE OE/Laser Conference, (Los Angeles, Calif., 1990), pp.: 1212-03. The holographic recording media described in Smothers et al., supra contain a photoimageable system containing a liquid monomer material (the photoactive monomer) and a photoinitiator (which promotes the polymerization of the monomer upon exposure to light), where the photoimageable system is in an organic polymer host matrix that is substantially inert to the exposure light. During writing (recording) of information into the material (by passing recording light through an array representing data), the monomer polymerizes in the exposed regions. Due to the lowering of the monomer concentration caused by the polymerization, monomer from the dark, unexposed regions of the material diffuses to the exposed regions. The polymerization and resulting diffusion create a refractive index change, thus forming the holographic grating (hologram) representing the data.

Photosensitive polymer films are considered attractive recording media candidates for high density holographic data storage. These films have a relatively low cost, are easily processed and can be designed to have large index contrasts with high photosensitivity. These films can also be fabricated with the dynamic range, media thickness, optical quality and dimensional stability required for high density applications. See L. Dhar et al., “Recording Media That Exhibit High Dynamic Range for Holographic Storage,” Optics Letters, 24, (1999): pp. 487 et. seq.

The polymer materials used in the holographic storage medium are often positioned or sandwiched between two glass or plastic plates or substrates to insure high optical quality. An area of disadvantage for these photopolymer films, even when sandwiched between glass or plastic substrates, is that the exposure to the various environmental factors can negatively affect the properties of these films. For example, exposure of these photopolymer films to an oxygen-containing environment (e.g., air), as well as moisture, may cause degradation of the photopolymer film, e.g., by reaction with the materials in the film, thus potentially causing permanent damage thereto. Such degradation may come in the form of reduced dynamic range of the photopolymer film and hence reduced storage of data, as well as reducing shelf life and archival life of the film.

### SUMMARY

According to a first broad aspect of the present invention, there is provided an article comprising: a pair of substrates each comprising a thermoplastic and each having an outer edge; a holographic storage medium positioned between the substrates such that the holographic storage medium has an exposed outer edge area proximate the outer edges of the substrates; and an environmental barrier seal protecting the exposed outer edge area from environmental degradants; wherein the environmental barrier seal comprises: an inner layer adhered to at least one of the substrates and comprising a thermally meltable adhesive; an outer layer comprising a moisture impervious plastic; an intermediate layer positioned between the inner and outer layers and comprising a moisture and oxygen impervious metallic foil; and an edge covering portion which covers the exposed outer edge area of the holographic storage medium and the outer edges of the substrates, wherein the edge covering portion includes a temperature-responsive stress-relieving structure and wherein the edge covering portion is adhered to the outer edge of each of the substrates.

According to a second broad aspect of the present invention, there is provided an article comprising: a pair of substrates each comprising a thermoplastic and each having an outer edge; a holographic storage medium positioned between the substrates such that the holographic storage medium has an exposed outer edge area proximate the outer edges of the substrates; and an environmental barrier seal protecting the exposed outer edge area from environmental degradants; wherein the environmental barrier seal comprises: an inner layer adhered to at least one of the substrates and comprising a thermally meltable adhesive; an outer layer comprising a moisture impervious plastic; and an intermediate layer positioned between the inner and outer layers and comprising a moisture and oxygen impervious metallic foil; wherein a portion of the environmental barrier seal comprises a temperature-responsive stress-relieving structure to thereby relieve stresses in the environmental barrier seal which may be caused by temperature changes.

According to a third broad aspect of the present invention, there is provided a process comprising the following steps of:
(a) providing an article comprising:
   a pair of substrates each comprising a thermoplastic and each having an outer edge;
   a holographic storage medium positioned between the substrates such that the holographic storage medium has an exposed edge area; and
   an environmental barrier seal to protect the edge exposed area from environmental degradants, wherein the environmental barrier seal comprises:
      an inner layer adhered to at least one of the substrates and comprising a thermally meltable adhesive;
      an outer layer comprising a moisture impervious plastic; and
      an intermediate layer positioned between the inner and outer layers and comprising a moisture and oxygen impervious metallic foil; and
(b) forming in a portion of the environmental barrier seal a temperature-responsive stress-relieving structure to thereby relieve stresses in the environmental barrier seal which may be caused by temperature changes.

According to a fourth broad aspect of the present invention, there is provided an article comprising: a pair of substrates each comprising a thermoplastic and each having an outer edge; a holographic storage medium positioned between the substrates such that the holographic storage medium has an exposed outer edge area proximate the outer edges of the substrates; and an environmental barrier seal protecting the exposed outer edge area from environmental degradants; wherein the environmental barrier seal comprises: an inner layer adhered to at least one of the substrates and comprising a thermally meltable adhesive; an outer layer comprising a moisture impervious plastic; and an intermediate layer positioned between the inner and outer layers and comprising a moisture and oxygen impervious metallic foil; wherein the substrates, holographic storage medium, and environmental barrier seal comprise materials which have compatible coefficients of thermal expansion.

### BRIEF DESCRIPTION OF THE DRAWINGS

Embodiments of the present invention will be described in conjunction with the accompanying drawings, in which:

FIG. 1 is a graphical plot for four different holographic storage discs showing typical pitch error of a holographic storage disc sealed with an environmental barrier seal covering the outer edge thereof prior to baking to simulate exposure to temperature extremes;

FIG. 2 is a graphical plot for the holographic storage discs of FIG. 1 showing the pitch error change after exposing the holographic storage discs to an 80° C. bake for 24 hours to simulate exposure to temperature extremes, and then remeasured at room temperature;

FIG. 3 is a graphical plot for four different holographic storage discs showing typical results of providing an environmental barrier seal, i.e., a 4.11 mm wide tape covering the outer edge of a holographic storage disc, prior to baking to simulate exposure to temperature extremes;

FIG. 4 is a graphical plot for the holographic storage discs of FIG. 3 showing typical results for the 4.11 mm wide tape after a 60° C. bake for 24 hours to simulate exposure to temperature extremes, and then remeasured at room temperature;

FIG. 5 is a graphical plot for four different holographic storage discs showing typical results for a 5 mm wide tape providing an environmental barrier seal covering the outer edge a holographic storage discs and prior to baking to simulate exposure to temperature extremes;

FIG. 6 is a graphical plot for the holographic storage discs of FIG. 5, showing typical results for the 5 mm wide tape after a 60° C. bake for 24 hours to simulate exposure to temperature extremes, and then remeasured at room temperature; and

FIGS. 7 and 8 are graphical plots for four different holographic storage discs sealed with an environmental barrier seal covering the outer edge thereof to show typical results from using a male form in place of a heated sealing roller for forming the seal;

FIG. 9 is a side sectional view showing a portion of an article of according to one embodiment of the present invention prior to thermal expansion;

FIG. 10 is a side sectional view showing a portion of an article of according to one embodiment of the present invention prior to thermal expansion;

FIG. 11 is a side sectional view showing a portion of an article of according to one embodiment of the present invention prior to thermal expansion;

FIG. 12 is a side sectional view showing a portion of an article of according to one embodiment of the present invention prior to thermal expansion;

FIG. 13 is a side sectional view showing a portion of an article of according to one embodiment of the present invention prior to thermal expansion; and

FIG. 14 is a side sectional view of an environmental barrier seal according to one embodiment of the present invention prior to affixation to the article of the present invention.

### DETAILED DESCRIPTION

It is advantageous to define several terms before describing the invention. It should be appreciated that the following definitions are used throughout this application.

### Definitions

Where the definition of terms departs from the commonly used meaning of the term, applicants intend to utilize the definitions provided below, unless specifically indicated.

For the purposes of the present invention, directional terms such as “top”, “bottom”, “above”, “below”, “left”, “right”, “horizontal”, “vertical”, “up”, “down”, etc., are merely used for convenience in describing the various embodiments of the present invention. The embodiments of the present invention may be oriented in various ways. For example, the devices, diagrams, graphs, images, etc., shown in the drawing figures may be flipped over, rotated by 90° in any direction, reversed, etc.

For the purposes of the present invention, the term “light source” refers to any source of electromagnetic radiation of any wavelength. The light source may be from a laser, a laser diode, a light emitting diode (LED), etc.

For the purposes of the present invention, the term “photoinitiating light source” refers to a light source that activates a photoinitiator, a photoactive polymerizable material, or both. Photoinitiating light sources include recording light, etc.

For the purposes of the present invention, the term “spatial light intensity” refers to a light intensity distribution or pattern of varying light intensity within a given volume of space.

For the purposes of the present invention, the terms “holographic grating,” “holograph” or “hologram” (collectively and interchangeably referred to hereafter as “hologram”) are used in the conventional sense of referring to an interference pattern formed when a signal beam and a reference beam interfere with each other. In cases where digital data is recorded page-wise, the signal beam may be encoded with a data modulator, e.g., a spatial light modulator, etc.

For the purposes of the present invention, the term “holographic recording” refers to the act of recording a hologram in a holographic storage medium. The holographic recording may provide bit-wise storage (i.e., recording of one bit of data), may provide storage of a 1-dimensional linear array of data (i.e., a 1×N array, where N is the number linear data bits), or may provide 2-dimensional storage of a page of data.

For the purposes of the present invention, the term “holographic storage medium” refers to a component, material, etc., that is capable of recording and storing, in three dimensions (i.e., the X, Y and Z dimensions), one or more holograms (e.g., bit-wise, linear array-wise or page-wise) as one or more patterns of varying refractive index imprinted into the medium. Examples of holographic media useful herein include, but are not limited to, those described in: U.S. Pat. No. 6,103,454 (Dhar et al.), issued Aug. 15, 2000; U.S. Pat. No. 6,482,551 (Dhar et al.), issued Nov. 19, 2002; U.S. Pat. No. 6,650,447 (Curtis et al.), issued Nov. 18, 2003, U.S. Pat. No. 6,743,552 (Setthachayanon et al.), issued Jun. 1, 2004; U.S. Pat. No. 6,765,061 (Dhar et al.), Jul. 20, 2004; U.S. Pat. No. 6,780,546 (Trentler et al.), issued Aug. 24, 2004; U.S. Patent Application No. 2003-0206320, published Nov. 6, 2003, (Cole et al.), and U.S. Patent Application No. 2004-0027625, published Feb. 12, 2004, the entire contents and disclosures of which are herein incorporated by reference.

For the purposes of the present invention, the term “data page” or “page” refers to the conventional meaning of data page as used with respect to holography. For example, a data page may be a page of data, one or more pictures, etc., to be recorded or recorded in a holographic storage medium.

For the purposes of the present invention, the term “recording light” refers to a light source used to record into a holographic storage medium. The spatial light intensity pattern of the recording light is what is recorded. Thus, if the recording light is a simple noncoherent beam of light, a waveguide may then be created, or if it is two interfering laser beams, then interference patterns will be recorded.

For the purposes of the present invention, the term “recording data” refers to storing or writing holographic data in a holographic storage medium.

For the purposes of the present invention, the term “reading data” refers to retrieving, recovering, or reconstructing holographic data stored in a holographic storage medium.

For the purposes of the present invention, the term “substrate” refers to components, materials, etc., associated with the holographic storage medium, and which often provide a supporting structure for the holographic storage medium, and may optionally provide other beneficial properties for the article, e.g., rendering the holographic storage medium optically flat, etc. In one embodiment of the present invention, a holographic storage medium is located between a pair of substrates. In the various embodiments of the article of the present invention employing a pair of substrates, one or both substrates may be optically transparent depending on whether radiation used to write data (e.g., recording light) needs to be transmitted through the substrate to the holographic storage medium. Each substrate comprises a thermoplastic (in whole or in part) such that the environmental barrier seal can be adhered thereto, for example, by a heat sealing process. It should be noted that other substrates know in the semiconductor art may be utilized with the teachings of this invention. For example, the substrates may be glass, semiconductor materials, conductive materials, etc. Each substrate may comprise a variety of thermoplastic materials, including those that are optically transparent to the radiation (e.g., recording light) used to write data, such as polycarbonates, poly(methyl methacrylate), cyclic olefin polymers, etc. Each substrate may also be optically opaque if transmission of radiation through the substrate to write data in the holographic storage medium is not required. Each substrate may have an antireflective coating that may be deposited or otherwise formed on the substrate by various processes known to those skilled in the art, such as chemical vapor deposition, etc. The substrate may consist essentially of thermoplastic (i.e., an entirely thermoplastic substrate), or may comprise other materials (e.g., glass) in addition to thermoplastic (e.g., a laminate of one or more layers of glass with one or more layers of thermoplastic). It should also be appreciated that the materials for each substrate may be different.

For the purposes of the present invention, the term “support matrix” refers to a material, medium, substance, etc., in which a polymerizable component is dissolved, dispersed, embedded, enclosed, etc. The support matrix is typically a low T_{g} polymer. The polymer may be organic, inorganic, or a mixture of the two. The polymer may also be either a thermoset or thermoplastic.

For the purposes of the present invention, the term “different form” refers to a product that is processed to produce a different physical form. For example, a holographic storage medium of the present invention comprising a block of material, powder of material, chips of material, etc. may be processed to form a molded product, a sheet, a free flexible film, a stiff card, a flexible card, an extruded film, etc.

For the purposes of the present invention, the term “particle material” refers to a material that is made by grinding, shredding, fragmenting or otherwise subdividing an article into smaller components or to a material that is comprised of small components such as a powder.

For the purposes of the present invention, the term “free flexible film” refers to a thin sheet of flexible material that maintains its form without being supported on an associated substrate. Examples of free flexible films include the various types of plastic wraps used in food storage.

For the purposes of the present invention, the term “stiff article' refers to an article that may crack or crease when bent. An example of a stiff article is a plastic credit card, a DVD, a transparency, wrapping paper, a shipping box, etc.

For the purposes of the present invention, the term “volatile compound” refers to any chemical with a high vapor pressure and/or a boiling point below about 150° C. Examples of volatile compounds include: acetone, methylene chloride, toluene, etc. An article, mixture or component is “volatile compound free” if the article, mixture or component does not include a volatile compound.

For the purposes of the present invention, the term “oligomer” refers to a polymer having approximately 30 repeat units or less or any large molecule able to diffuse at least about 100 nm in approximately 2 minutes at room temperature when dissolved in a holographic storage medium of the present invention. Such oligomers may contain one or more polymerizable groups whereby the polymerizable groups may be the same or different from other possible monomers in the polymerizable component. Furthermore, when more than one polymerizable group is present on the oligomer, they may be the same or different. Additionally, oligomers may be dendritic. Oligomers are considered herein to be photoactive monomers, although they are sometimes referred to as “photoactive oligomer(s)”.

For the purposes of the present invention, the term “photopolymerization” refers to any polymerization reaction caused by exposure to a photoinitiating light source.

For the purpose of the present invention, the term “photoinitiator” refers to the conventional meaning of the term photoinitiator and also refers to sensitizers and dyes. In general, a photoinitiator causes the light initiated polymerization of a material, such as a photoactive oligomer or monomer, when the material containing the photoinitiator is exposed to light of a wavelength that activates the photoinitiator, i.e., a photoinitiating light source. The photoinitiator may refer to a combination of components, some of which individually are not light sensitive, yet in combination are capable of curing the photoactive oligomer or monomer, examples of which include a dye/amine, a sensitizer/iodonium salt, a dye/borate salt, etc.

For the purposes of the present invention, the term “photoinitiator component” refers to a single photoinitiator or a combination of two or more photoinitiators. For example, two or more photoinitiators may be used in the photoinitiator component to allow recording at two or more different wavelengths of light.

For the purposes of the present invention, the term “polymerizable component” refers to a mixture of one or more photoactive polymerizable materials, and possibly one or more additional polymerizable materials (i.e., monomers and/or oligomers) that are capable of forming a polymer.

For the purposes of the present invention, the term “photoactive polymerizable material” refers to a monomer, an oligomer and combinations thereof that polymerize in the presence of a photoinitiator that has been activated by being exposed to a photoinitiating light source, e.g., recording light. In reference to the functional group that undergoes curing, the photoactive polymerizable material comprises at least one such functional group. It is also understood that there exist photoactive polymerizable materials that are also photoinitiators, such as N-methylmaleimide, derivatized acetophenones, etc. In such a case, it is understood that the photoactive monomer and/or oligomer of the present invention may also be a photoinitiator.

For the purposes of the present invention, the term “photopolymer” refers to a polymer formed by one or more photoactive polymerizable materials, and possibly one or more additional monomers and/or oligomers.

For the purposes of the present invention, the term “plasticizer” refers to the conventional meaning of the term plasticizer. In general, a plasticizer is a compound added to a polymer both to facilitate processing and to increase the flexibility and/or toughness of a product by internal modification (salvation) of a polymer molecule.

For the purposes of the present invention, the term “thermoplastic” refers to the conventional meaning of thermoplastic, i.e., a composition, compound, material, medium, substance, etc., that exhibits the property of a material, such as a high polymer, that softens when exposed to heat and generally returns to its original condition when cooled to room temperature. Examples of thermoplastics include, but are not limited to: poly(methyl vinyl ether-alt-maleic anhydride), poly(vinyl acetate), poly(styrene), poly(ethylene), poly(propylene), cyclic olefin polymers, poly(ethylene oxide), linear nylons, linear polyesters, linear polycarbonates, linear polyurethanes, etc.

For the purposes of the present invention, the term “room temperature thermoplastic” refers to a thermoplastic that is solid at room temperature, i.e., will not cold flow at room temperature.

For the purposes of the present invention, the term “room temperature” refers to the commonly accepted meaning of room temperature, i.e., an ambient temperature of 20°-25° C.

For the purposes of the present invention, the term “thermoset” refers to the conventional meaning of thermoset, i.e., a composition, compound, material, medium, substance, etc., that is crosslinked such that it does not have a melting temperature. Examples of thermosets are crosslinked poly(urethanes), crosslinked poly(acrylates), crosslinked poly(styrene), etc.

For the purposes of the present invention, the term “exposed area” refers to those portions of the holographic storage medium, “slip layers”, etc., that would be exposed to environmental degradants in the absence environmental barrier seals.

For the purposes of the present invention, the term “environmental degradant” refers at least to moisture, oxygen (e.g., in air), or combinations thereof.

For the purposes of the present invention, the term “relative humidity” (RH) refers to the percentage relation between the actual amount of water vapor in a given volume of air at a definite temperature and the maximum amount of water vapor that would be present if the air environment were saturated with water vapor at that temperature. RH is typically measured herein at temperatures of about 60° C. or higher, more typically about 80° C. or higher.

For the purposes of the present invention, the term “environmental barrier seal” refers to a seal that is protective against environmental degradants, i.e., has a relatively low water vapor transmission rate and/or oxygen transmission rate, especially in environments having relatively high RHs (e.g., about 90% or greater, more typically about 95% or greater), and comprises a plurality of layers, including a thermally meltable adhesive-comprising layer, a moisture impervious plastic-comprising layer, and a metallic foil-comprising layer positioned between the thermally meltable adhesive-comprising layer and the moisture impervious plastic-comprising layer. Usually, the environmental barrier seal provides effective protection again environment degradants at temperatures of about 38° C. or higher, typically about 60° C. or higher, more typically about 80° C. or higher, at a relative humidity of about 90% or greater, more typically about 95% or greater, and for time periods of about 200 hours or greater, more typically about 1000 hours or greater. The thickness of the environmental barrier seal typically depends upon the bulk or stock material (e.g., foil barrier laminate material) that the seal is formed from. Usually, the environmental barrier seal has a thickness of up to about 10 mils (254 microns) or less, and typically in the range of from about 3 to about 10 mils (from about 76 to about 254 microns), more typically from about 4 to about 5 mm (from about 102 to about 127 microns).

For the purposes of the present invention, the term “laminate” refers to one or more layers that are united as a composite. In at least some embodiments, the layer(s) are typically superimposed. Laminate materials usefully in forming environmental barrier seals are referred to herein as “foil barrier laminates” or “foil environmental barrier laminates,” and may be provided in bulk or stock form as sheets, webs, films, etc. Illustrative foil barrier laminates for use herein include but are not limited to: PAKVF4™ (provided by Impak Corp. of Los Angeles Calif.), MarvelSeal 360™ and MarvelSeal FR2175™ (provided by Berry Plastics Covalence Coated Products of Homer, La.), etc. In addition, this term does include barriers where “foils” are not utilized. One such product is made by Honeywell as Aclam EL-100™.

For the purposes of the present invention, the term “adhered” refers to one material (e.g., seal, layer, substrate, medium, etc.) being glued, fused, bonded, attached, affixed, etc., to another material (e.g., seal, layer, substrate, medium, etc.) at an edge, surface, or other interface between the materials.

For the purposes of the present invention, the term “adhesive” refers to a composition, substance, film, etc., that is capable of gluing, fusing, bonding, attaching, affixing, etc., one material (e.g., seal, layer, substrate, medium, etc.) to another material (e.g., seal, layer, substrate, medium, etc.) at an edge, surface, or other interface between the materials.

For the purposes of the present invention, the term “thermally meltable adhesive” refers to an adhesive material that melts or is molten upon heating (e.g., is heat sealable), typically at a temperature of about 150° C. or higher, more typically at a temperature of about 175° C. or higher. Suitable thermally meltable adhesives include one or more materials such as thermoplastic films comprising one or more of polyethylene, including low density polyethylene (LDPE) and linear low density polyethylene (LLDPE), polypropylene, copolymers of ethylene and propylene, terpolymers of ethylene, vinyl acetate and maleic anhydride, terpolymers of ethylene, vinyl acetate and acrylic acid polyester, ethylene vinyl acetate copolymers, ethylene methyl acrylate copolymers, ethylene butyl acrylate copolymers, etc.

For the purposes of the present invention, the term “metallic foil” refers to a relatively thin sheet, piece, etc., comprising one or more layers of metal or a metal alloy. Suitable metallic foils may comprise aluminum foil, stainless steel foil, gold foil, platinum foil, palladium foil, zinc foil, etc., as well as alloys thereof. Metallic foils useful herein, for example, aluminum foils, typically have a thickness of at least about 0.25 mils (6.3 microns), and typically from about 0.25 to about 0.4 mm (from about 6.3 to about 10.1 microns), more typically from about 0.28 to about 0.35 mils (from about 7.1 to about 8.9 microns).

For the purposes of the present invention, the term “tie layer” refers to an adhesive layer (e.g., a self-adhesive layer, a thermally meltable adhesive layer, etc.) between two other layers that attaches, adheres, glues, fuses, bonds, etc., these other layers to one another. Tie layers may be used to attach, adhere, glue, fuse, bond, etc., two layers together that are otherwise difficult to adhere together or cannot be adhered to another because of differing compositions (e.g., one layer is plastic, the other layer is metallic), differing coefficients of thermal expansion, differing coefficients of friction or adhesion, etc. Suitable tie layers may be comprised of one or more adhesive materials, one or more film-forming thermoplastic polymeric materials, or combinations of adhesive and film-forming thermoplastic polymeric materials. These adhesive materials may include ethylene vinyl acetate copolymers, ethylene methyl acrylate copolymers, ethylene butyl acrylate copolymers, etc., as well as combinations thereof. An example of a commercially available material that may be used is an ethylene methyl acrylate copolymer available from Exxon Mobil under the trade designation Optema TC 120. The film-forming thermoplastic polymeric materials that may be used include low density polyethylene (LDPE) and linear low density polyethylene (LLDPE), medium density polyethylene (density of about 0.924 to about 0.939 g/cc), polypropylene, copolymers of ethylene and propylene, terpolymers of ethylene, vinyl acetate and maleic anhydride, terpolymers of ethylene, vinyl acetate and acrylic acid, etc., as well as various combinations thermoplastics. An example of a commercial thermoplastic polymeric material that may be used is Union Carbide-Dow 5A97.

For the purposes of the present invention, the term “water vapor transmission rate” (WVTR) refers to the rate at which water vapor or moisture passes through or is transmitted through a environmental barrier material such as a layer, film, laminate, seal, etc., and may be a function of the size and frequency of the micropores in the layer, film, laminate, seal, etc. A normalized value may be used to compare the respective WVTR of various layers, film, laminates, seals, etc. One method that may be used to define WVTR is by ASTM F1249 (e.g., at 38° C. and 90% RH).

For the purposes of the present invention, the term “moisture impervious” refers to the ability of a material, laminate, film, layer, seal, etc., to minimize, reduce, inhibit, prevent, etc., the transmission of water vapor or moisture therethrough. Materials, laminates, films, layers, seals, etc., useful herein that are moisture impervious have a relatively low or minimal WVTR, typically of about 0.02 g./100 in.²/day or less, more typically about 0.005 g./100 in.²/day or less, as measured by ASTM F1249.

For the purposes of the present invention, the term “moisture impervious plastic” refers to a thermoplastic polymer that is moisture impervious and may be flexible (e.g., can be formed as a film). Suitable moisture impervious plastics for use herein include one or more of polyesters and copolyesters (e.g., polyethylene terephthalate (PET), etc.), polypropylene, polytetrafluoroethylene (e.g., Teflon, etc.), nylon, polystyrene, polycarbonate, acrylonitrile, polyvinyl chloride (PVC), polyvinyl dichloride (PVDC), ethylene vinyl alcohol (EVOH), polyvinylidene chloride (e.g., saran, etc.), ionomer-based polymers (e.g., Surlyn, etc.), polyethylene (e.g., HDPE, LDPE, etc.), etc., as well as blends and combinations of these plastics.

For the purposes of the present invention, the term “oxygen permeability” refers to the ability of a material, laminate, film, layer, seal, etc., to permit, allow, etc., the transmission of oxygen therethrough. Oxygen permeability may be measured in accordance with ASTM D3985-81, ASTM D1434, or DIN 53380 at an O₂ concentration of 1% at 1 atmosphere and 23° C.

For the purposes of the present invention, the term “oxygen impervious” refers to the ability of a material, laminate, film, layer, seal, etc., to reduce, inhibit, prevent, etc., the rate of transmission of oxygen therethrough. Materials, laminates, films, layers, environmental barrier seals, etc., useful herein that are oxygen impervious have a relatively low or minimal oxygen permeability rate, typically of about 10 cc/100 in.²/day or less, more typically about 1 cc/100 in.²/day or less.

For the purposes of the present invention, the term “isotropic” is used to describe the ability of a material, medium, etc., to physically expand or contract equally or substantially equally in all linear directions or dimensions, i.e., the X, Y and Z directions or dimensions, in response to thermally-induced changes, i.e., changes in temperature.

For the purposes of the present invention, the term “anisotropic” is used to describe a material, medium, etc., whose physical expansion or contraction in response to thermally-induced changes, i.e., changes in temperature, varies in one or more linear directions or dimensions, i.e., the response to thermally-induced changes is not equal in the X, Y and Z directions or dimensions.

For the purposes of the present invention, the term “X-Y plane” typically refers to the plane defined by the substrates or the holographic storage medium that encompasses the X and Y linear directions or dimensions. The X and Y linear directions or dimensions are typically referred to herein, respectively, as the dimensions known as length (i.e., the X-dimension) and width (i.e., the Y-dimension).

For the purposes of the present invention, the terms “Z-direction” and “Z-dimension” refer interchangeably to the linear dimension or direction perpendicular to the X-Y plane, and is typically referred to herein as the linear dimension known as thickness. The Z-direction/dimension is typically used herein with reference to the physical expansion or contraction of the holographic storage medium in response to thermally-induced changes, i.e., changes in temperature.

For the purposes of the present invention, the terms “coefficient of thermal expansion” and “coefficient of linear expansion” (collectively and interchangeably referred to hereafter as “CTE”) are used to refer to the relative expansion and/or contraction of a material, medium, etc., in one or more linear directions or dimensions in response to temperature, or changes in temperature. All CTE values referred to herein are in terms of ppm per° C. unless otherwise indicated. For example, a CTE value of “240” means “240 ppm per ° C.”

For the purposes of the present invention, the terms “differs in CTE values,” “difference in CTE values” and the like refer to a measurable difference between the CTE value of the holographic storage medium and the CTE value of the associated substrate such that the holographic storage medium exhibits anisotropic or substantially anisotropic behavior.

For the purposes of the present invention, the term “CTE compensating interface” refers to any interface between the holographic storage medium and an associated substrate that adjusts for, adjusts to, corrects for, or otherwise compensates for differences in the CTE values between the holographic storage medium and the associated substrate so that the holographic storage medium exhibits more isotropic behavior (i.e., has less anisotropic behavior) relative to changes in temperature. A CTE compensating interface often “decouples” the CTE properties of the holographic storage medium from the CTE properties of the associated substrate such that the holographic storage medium and associated substrate respond, function, etc., independently or substantially independently with respect to CTE effects, e.g., those caused by changes in temperature, etc.

For the purposes of the present invention, the term “interface,” with regard to the term “CTE compensating interface,” may refer to a boundary, layer, zone, region, area, etc.

For purposes of the present invention, the term “temperature-responsive stress-relieving structure” refers to a structure which is formed in, created in, imparted to, etc., a portion of an environmental barrier seal, or in the material (e.g., sealing film) used in providing the environmental barrier seal, which expands or contracts in response to temperature changes, including temperature cycling, to relieve stresses in the environmental barrier seal, substrates, or holographic storage medium which may be caused by such temperature changes, and which may cause undesired effects such as edge distortion, etc., of articles comprising these components. Such stress-relieving structures which may be formed in, created in, shaped in, imparted to, etc., a portion of an environmental barrier seal may include folds, creases, pleats, gathers, bellows, etc.

For the purposes of the present invention, the term “compatible coefficients of thermal expansion” refers to when the substrates, recording layer, and the seals have similar coefficients such that the differences in expansions of each do not induce undesirable stresses.

For purposes of the present invention, the term “pitch error” refers to the deviation angle between the write reference beam scanning plane and the exiting signal from the optical medium.

For the purposes of the present invention, the term “positional camera array” refers to detectors or sensors capable of detecting the presence or intensity of light. These arrays may be one-dimensional (linear), two-dimensional, or three-dimensional. These arrays may include a photodiode array (e.g. a bicell or quad cell photodiode), a CMOS camera, a CCD (e.g., a CCD linear array), etc.

### Description

Environmental exposure to environmental degradants, such as moisture and/or oxygen, may also result in the photopolymer of a holographic storage medium absorbing moisture, thus causing the photopolymer to swell and undergo refractive index changes in a spatially non-uniform fashion. When the photopolymer film is sandwiched between glass or plastic substrates, the non-uniform swelling and/or refractive index change in the polymer may diminish the optical quality of the holographic storage medium, e.g., by changing the optical properties of the film, including optical flatness. See, for example, U.S. Pat. No. 6,160,645 (Chandross et al.), issued Dec. 12, 2000 (hermetic seal comprising metal foils attached to plates having photosensitive polymer therebetween); and U.S. Pat. No. 6,671,073 (Hegel), issued Dec. 30, 2003 (holographic optical data storage device that includes photopolymer between upper and lower substrates having first and second peripheral edges respectively with an opening formed therebetween, and a connection member engaged to the upper and lower substrates wherein the connection member seals the opening).

Commonly assigned U.S. Pat. No. 7,173,744 (Whiteside et al.), issued Feb. 6, 2007, the entire disclosure and contents of which is hereby incorporate by reference, (hereafter Whiteside et al. '744 patent) is directed at articles and processes for addressing the problems created by environmental exposure to environmental degradants, such as moisture and/or oxygen,. Articles disclosed by the Whiteside et al. '744 patent may comprise: (a) a pair of substrates comprising a thermoplastic; (2) a holographic storage medium (as previously described) positioned between the substrates and having at least one exposed area; and (3) one or more environmental barrier seals to protect the at least one exposed area. These environmental barrier seals for the potentially exposed areas of the medium between the pair of substrates are provided to protect the medium from environmental degradants, such as moisture and/or oxygen. These environmental barrier seals may further comprise: (a) an inner layer comprising a thermally meltable adhesive that is adhered to the substrates; (b) an outer layer comprising a moisture impervious plastic; (c) an intermediate layer positioned between the inner and outer layers and comprising a moisture and oxygen impervious metallic foil; and (d) optionally a tie layer between the outer and intermediate layers.

An illustrative example of a suitable environmental barrier seal material for the Whiteside et al. '744 patent articles is a heat sealable foil barrier laminate such as PAKVF4, MarvelSeal 360 or MarvelSeal FR2175, etc. These heat sealable foil barrier laminates have a heat sealable thermally meltable adhesive layer that, when subjected, for example, to the heat sealing process of the Whiteside et al. '744 patent, welds, fuses, glues or otherwise bonds the laminate to the substrates because of the melting, welding, fusing, gluing or bonding together of the adhesive layer and the melted portion of the substrate. The metallic (e.g., aluminum) foil layer sandwiched between the adhesive and tie layers of the heat sealable foil barrier laminate provides effective environmental barrier protection against both oxygen and water vapor, and is flexible and easily conforms to the outer peripheral edge of each of the substrates. These heat sealable foil barrier laminates may also provide additional moisture protection by having an outer moisture impervious layer adhered to the metallic foil layer, typically by the tie layer.

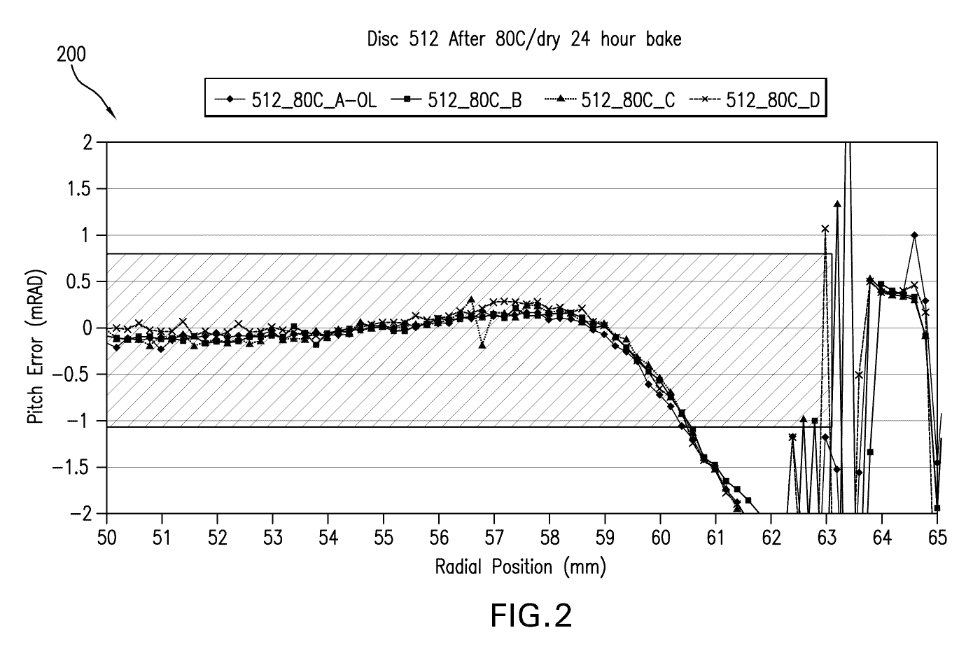

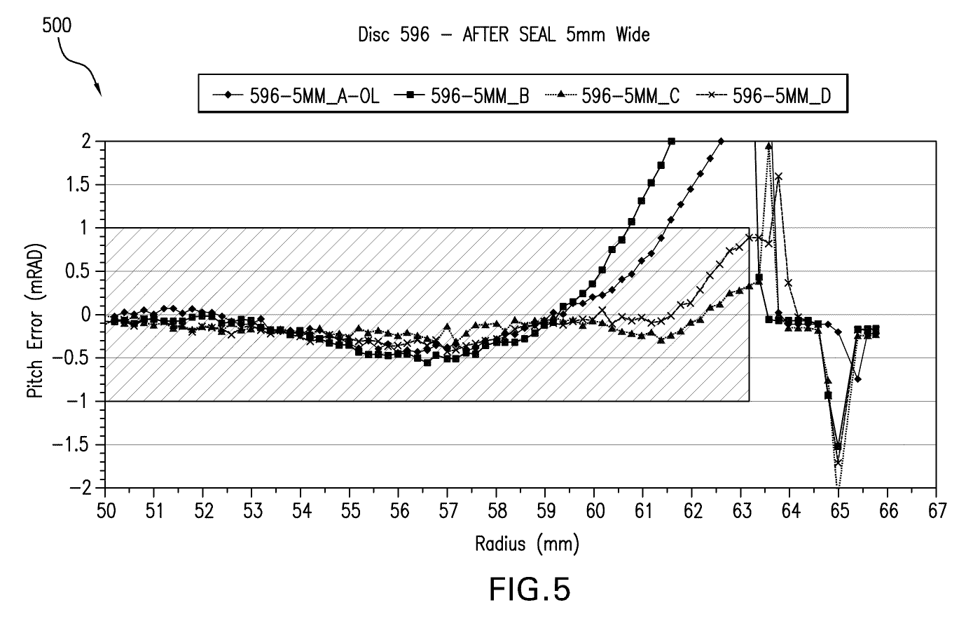

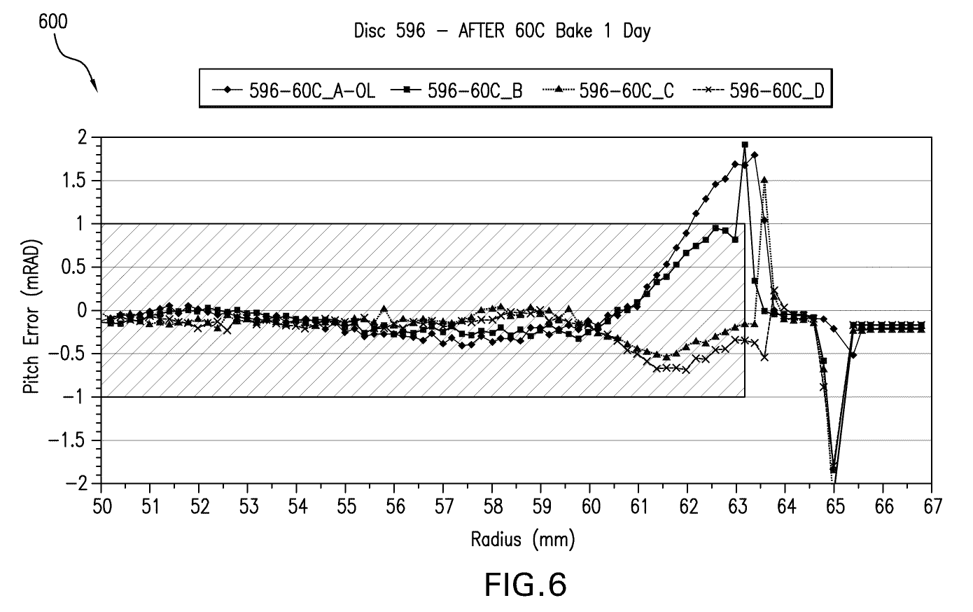

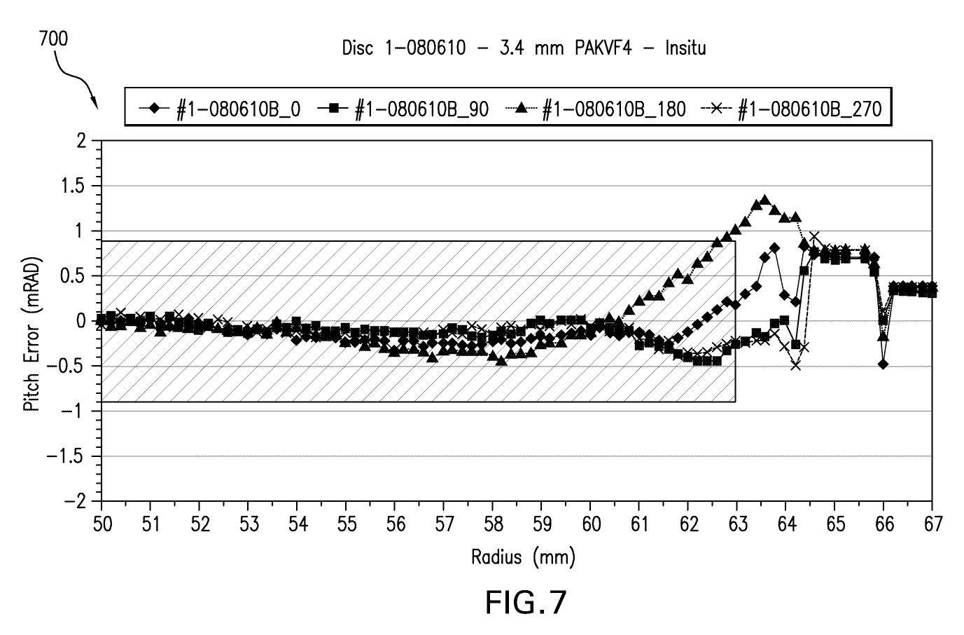

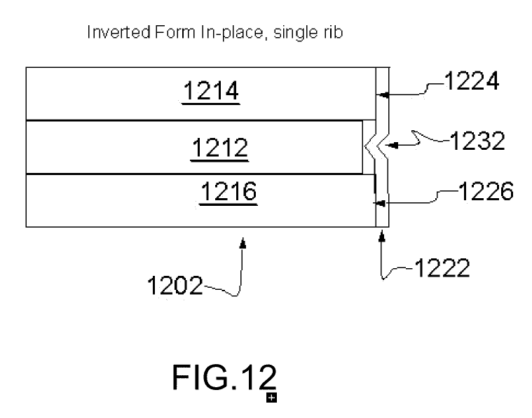

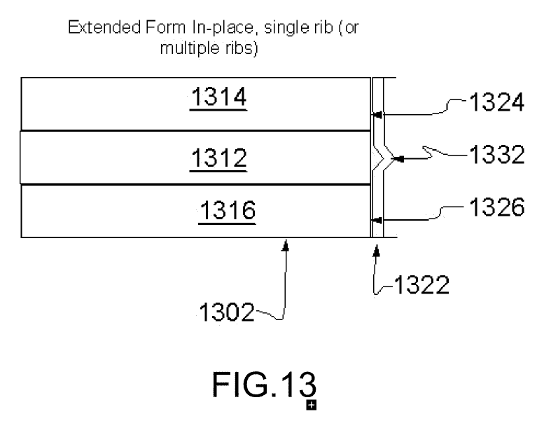

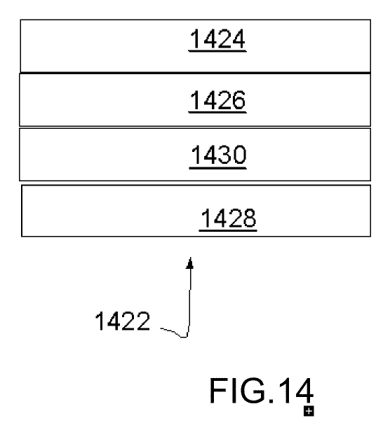

Various embodiments of these articles are illustrated in FIGS. 2-11 of the Whiteside et al. '744 patent. FIGS. 2-4 of the Whiteside et al. '744 patent illustrate one embodiment of such an article having an outer generally annular peripheral edge environmental barrier seal secured, attached or otherwise adhered to the peripheral edge and a generally circular upper central environmental barrier seal having an outer peripheral edge that extends beyond the perimeter a generally circular central aperture. FIG. 5 of Whiteside et al. '744 patent shows an alternative embodiment for sealing the upper and lower exposed central area of the holographic storage medium. An embodiment of an environmental barrier material that can be used in such environmental barrier seals is illustrated in FIG. 6 of Whiteside et al. '744 patent. An embodiment of an article comprising the holographic storage medium and associated substrates which is isotropic with regard to thermally induced-dimensional changes which further comprises an edge environmental barrier seals and CTE compensating “slip layers” is further illustrated by FIG. 7 of the Whiteside et al. '744 patent. These environmental barrier seals may be heat sealed by using heat sealing apparatus illustrated in, for example, in FIGS. 12-13, or FIGS. 14-15, of Whiteside et al. '744 patent.

The environmental barriers seals of the articles disclosed in Whiteside et al. '744 patent need to not only provide an effective water (moisture) vapor barrier, but are designed so that they do not distort, or induce any distortions in, the geometrical profile of the edge or edge area of the holographic storage medium. Due to the potential composition, characteristics, properties, etc., of the seal material, the environmental barrier seal may, without proper design and after exposure to storage temperature extremes and cycling, cause a change in the flatness of the holographic storage medium in the seal area, i.e., at the edge or edge area of the holographic storage medium. What has been discovered when using embodiments of the present invention is that the same seal materials may be used in these environmental barrier seals, but after modification, for example: (1) by pre-forming the environmental barrier seal tape material, before or during the sealing process, to a shape that allows for minimal effects on the holographic storage medium after exposing to temperatures extremes; (2) by adjusting the width of the environmental barrier seal relative to the outer edges of the substrates; (3) by choosing materials for the substrates, holographic storage medium, and environmental barrier seals which have matching or compatible coefficients of thermal expansion; (4) etc.

This edge distortion in the edge area of the holographic storage medium where the environmental barrier seal is provided may be characterized by measuring the pitch error of a laser beam which is projected through the medium onto a positional camera (pixel) array. Any change or distortion of the edge area of the holographic storage medium may affect the laser beam path though the medium, thus causing a difference in the centroid position of the laser beam on the positional camera array.

During the process of sealing the environmental barrier film at the edges of the substrates between which the holographic storage medium is positioned, the heat applied during the sealing process may cause certain edge effects to the article, especially in the edge area of the holographic storage medium, after the seal is cooled. Any subsequent exposure to temperature extremes, such as up to about 80° C., may cause the material in the edge area of the holographic storage medium to expand at a greater rate compared to the material comprising the substrates, or the seal material, due to the difference in the coefficient of thermal expansion (CTE) properties. This expansion differential may then impart a stress to the seal material which may tend to creep under the load. After cooling back to room temperature, this residual creep induced stress may cause a change which may then result in an edge distortion at the edge or edge area of the holographic storage medium where the environmental barrier seal is located.

It has been found herein that the sealing film for the environmental barrier seal adheres only to the substrates but does not adhere to the holographic storage medium layer. It should be appreciated by only having adhesion to at least one substrate, the environmental barrier may move independent of the holographic storage medium layer. Sealing films for the environmental barrier seal which have an excess width, i.e. greater than the combined width of the substrates and holographic storage medium layer, reduces the stress on the film during the temperature extremes which may be caused by the greater expansion or contraction of the holographic storage medium layer. It should be appreciated that the wider width gives more flexibility to the in the non-adhered space between the substrates, i.e. the medium area. IT should be appreciated that the narrower the film width, it will be stretched more during the thermal expansion and cause more film stress. This stress is thought to cause the film to creep and not return to it's original dimension. The wider tape has less stress build up and therefore less change due to creep. This advantageous invention was discovered from the pitch error plots showing reduced error as the tape increases in width.

Embodiments of the present invention relate to the discovery of the cause of the edge distortion in the edge area of the holographic storage medium layer when using environmental barrier seals. In addition, embodiments of methods of the present invention which reduce the effect(s) caused by such distortion which induce stress in the environmental barrier seal (e.g., sealing film layer) are also provided. These methods may be designed, for example, to reduce the sealing film stress caused by the difference in thermal expansion of the different materials used in the sealing film, the holographic storage medium (layer), substrates between which the medium is positioned, etc.

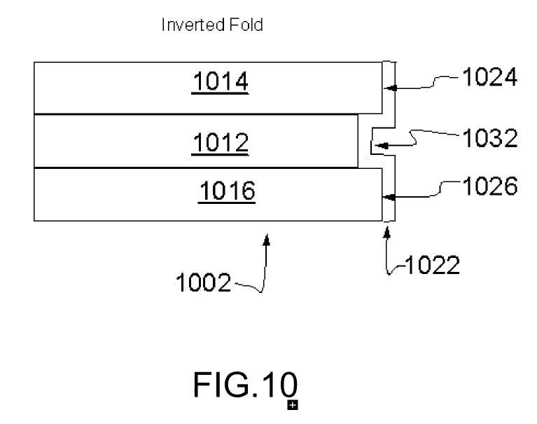

Embodiments of the present invention may provide possible solutions to relieve the edge distortion in the edge area of the holographic storage medium caused by the residual stresses which remain after cycling through temperature extremes. These solutions may include: (1) increasing the width of the environmental barrier seal (e.g., the sealing film) with respect to the combination of the substrates and storage medium; (2) pre-forming the environmental barrier seal (e.g. the sealing film) by incorporating, for example, temperature-responsive stress-relieving structure such as a fold, crease, pleat, gather, bellows, etc.; (3) utilizing, for example, a shaped sealing roller which imparts temperature-responsive stress-relieving structure, such as a fold, crease, pleat, gather, bellows, etc., into the tape material being sealed to provide the environmental barrier seal as illustrated in FIGS. 10 through 13; (4) matching the CTE of the relevant materials involved in the process of forming the environmental barrier seal. In addition, these solutions may desirably provide environmental barrier edge seals which minimize, reduce, inhibit, prevent, etc., edge distortions from appearing in the edge area of the holographic storage medium after temperature cycling.

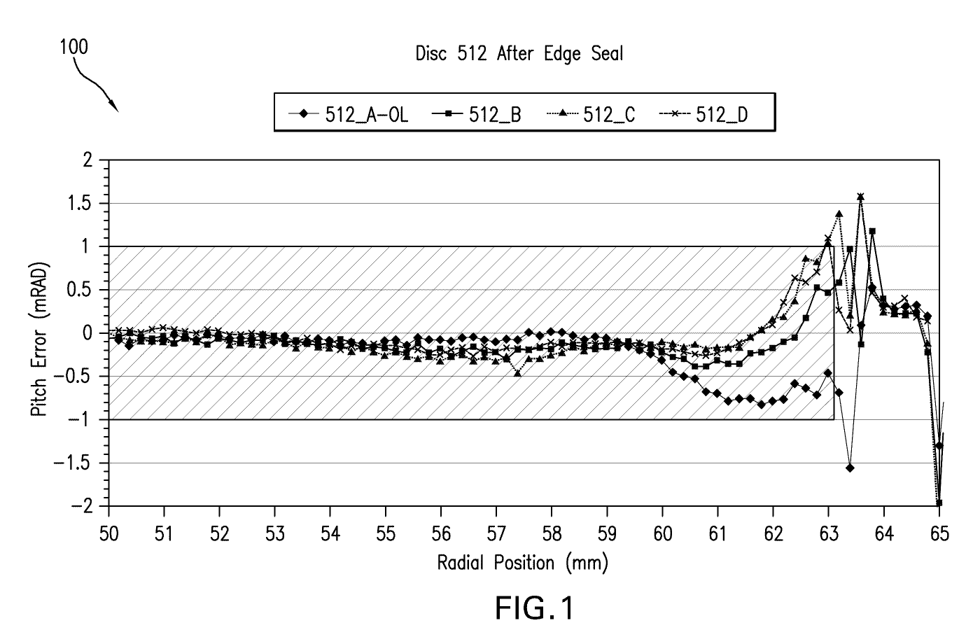

FIGS. 1 and 2 are graphical plots (indicated respectively as 100 and 200) which illustrate the edge distortion caused by a_representative width (e.g., 3.4 mm) of sealing tape. The results shown in FIGS. 1 and 2 show the measured pitch error of using a 3.4 mm wide sealing tape, before and after elevated temperature exposure. The pitch error measurement is taken at four points, A, B, C and D. They correspond to positions at 90 degrees apart from each other. The data is taken along a radial spoke starting at 50 mm radius and proceeding outward to the edge of the disc which is at the 65 mm radius. Also the spoke, the pitch error was measured at every 0.2 mm increments. The shaded box represents acceptable pitch error This criteria is used for all of the graphs in the present application.

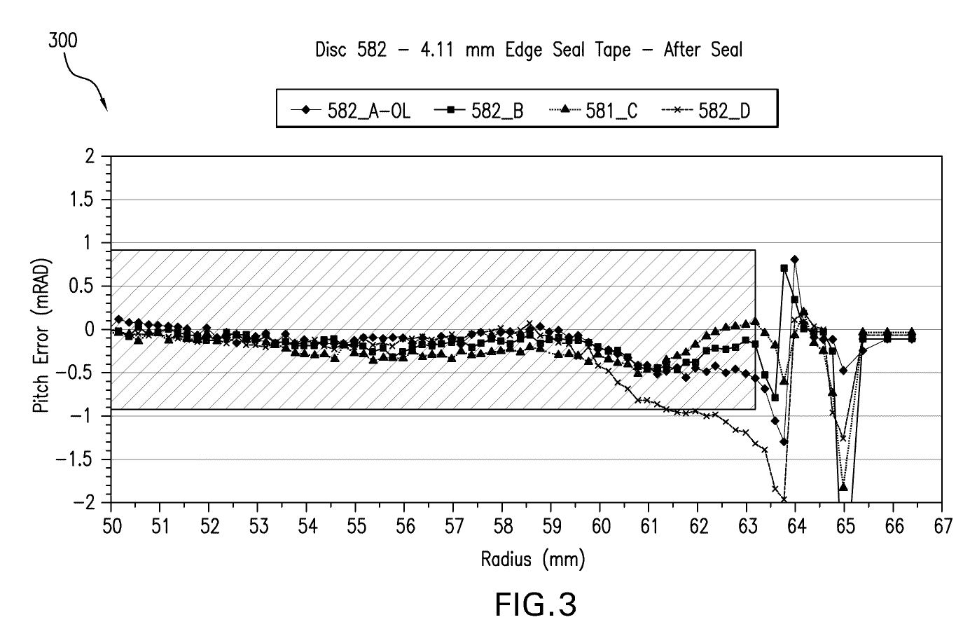

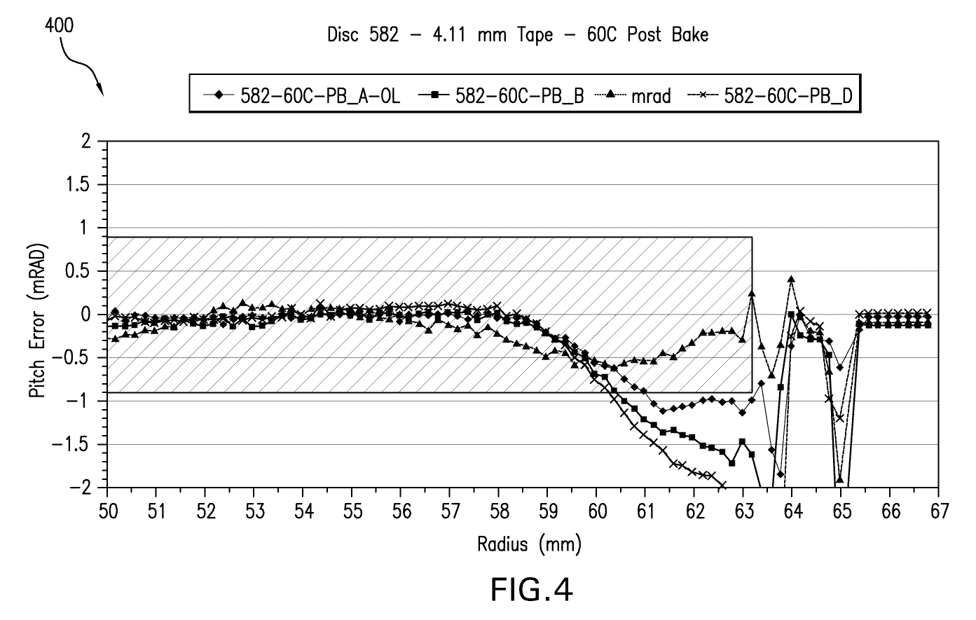

FIGS. 3 and 4 are graphical plots (indicated respectively as 300 and 400) which illustrate the benefits of increasing the width of the sealing film, as well as confining the edge of the sealing film so that there is no overhang of the sealing film beyond the substrate edge, in reducing the magnitude of the pitch error change. As may be seen from FIG. 4, there is a substantial improvement in the performance of the product. This is illustrated by the increased number of data points that are located in the box in FIG. 4 versus FIG. 2.

FIGS. 5 and 6 are graphical plots (indicated respectively as 500 and 600) which illustrate the benefits of incorporating a fold, bellows, etc., into the sealing tape so that a wider tape may be used, yet still be fed into a sealing machine (for example, the apparatus illustrated in FIGS. 12-13 or FIGS. 14-15 of the Whiteside et al. '744 patent) so that the nominal width equals the width of the media package width. In particular, FIGS. 5 and 6 show the result of using a 5 mm wide sealing tape which is folded into a “V-shape” and then run through an existing sealing machine (such as that shown in FIGS. 12-13 or FIGS. 14-15 of the Whiteside et al. '744 patent). The improvement in performance may be seen in FIG. 6 by the increased data points in the acceptable region.

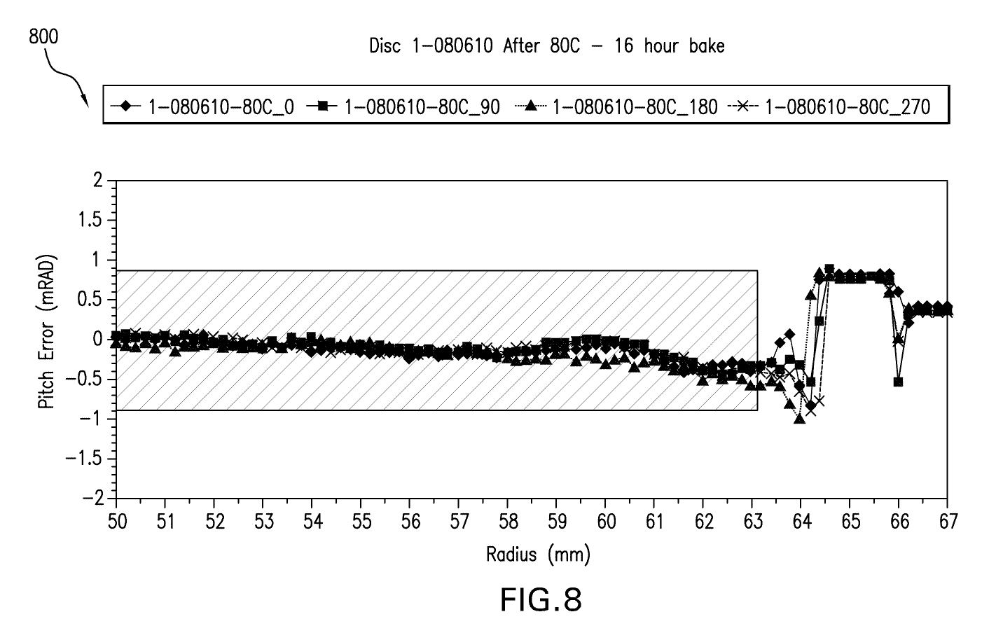

FIGS. 7 and 8 are graphical plots (indicated respectively as 700 and 800) which illustrate the benefits of using a shaped sealing roller to impart a fold, bellows, etc., into the sealing tape at the time of forming the environmental barrier seal. FIGS. 7 and 8 show a typical result for a 3.4 mm wide sealing tape which is sealed to provide an environmental barrier seal using a male form in place heated sealing roller.

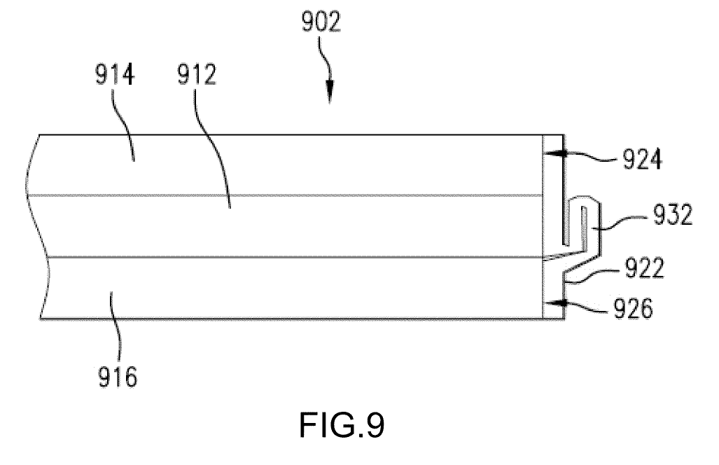

FIG. 9 is a side sectional view of an embodiment of an article of the present invention, indicated generally as 902, in which a holographic storage medium 912 is positioned or sandwiched between two substrates 914 and 916. A sealing tape 922 may be adhered to outer edges 924 and 926 of substrates 914 and 916, respectively, to form the environmental barrier seal. Sealing tape 922 may include a stress relieving region or structure or, indicated as 932, which may in the form of, for example, a fold.

FIG. 10 is a side sectional view of an embodiment of an article of the present invention, indicated generally as 1002, in which a holographic storage medium 1012 is positioned or sandwiched between two substrates 1014 and 1116. A sealing tape 1022 may be adhered to outer edges 1024 and/or 1026 of substrates 1014 and/or 1016, respectively, to form the environmental barrier seal. Sealing tape 1022 may include a stress relieving region or structure or, indicated as 1032, which may in the form of, for example, a step, rectangular or square shape.

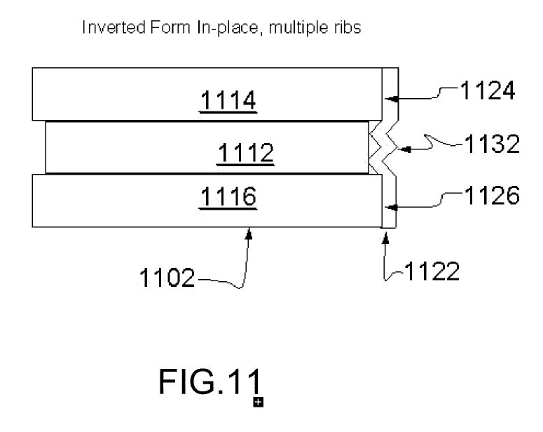

FIG. 11 is a side sectional view of an embodiment of an article of the present invention, indicated generally as 1102, in which a holographic storage medium 1112 is positioned or sandwiched between two substrates 1114 and 1116. A sealing tape 1122 may be adhered to outer edges 1124 and/or 1126 of substrates 1114 and/or 1116, respectively, to form the environmental barrier seal. Sealing tape 1122 may include a stress relieving region or structure or, indicated as 1132, which may in the form of, for example, a periodic indentation/peak and/or mesas/valleys which may be uniform or non-uniform. For clarity, only the uniform periodic indentation has been illustrated.

FIG. 12 is a side sectional view of an embodiment of an article of the present invention, indicated generally as 1202, in which a holographic storage medium 1212 is positioned or sandwiched between two substrates 1214 and 1216. A sealing tape 1222 may be adhered to outer edges 1224 and/or 1226 of substrates 1214 and/or 1216, respectively, to form the environmental barrier seal. Sealing tape 1222 may include a stress relieving region or structure or, indicated as 1232, which may in the form of, for example, a single indentation/peak or mesa/valley which may be uniform or non-uniform. For clarity, only the uniform indentation has been illustrated.

FIG. 13 is a side sectional view of an embodiment of an article of the present invention, indicated generally as 1302, in which a holographic storage medium 1312 is positioned or sandwiched between two substrates 1314 and 1316. A sealing tape 1322 may be adhered to outer edges 1324 and/or 1326 of substrates 1314 and/or 1316, respectively, to form the environmental barrier seal. Sealing tape 1322 may include a stress relieving region or structure or, indicated as 1332, which may in the form of, for example, a single indentation/peak or mesa/valley which may be uniform or non-uniform. For clarity, only the uniform indentation has been illustrated. It is to be appreciated that FIG. 13 is the negative profile of FIG. 12. In addition, while elements 1232 and 1332 are illustrated as being disposed directly between the respective substrates, they may be disposed at any location between the respective substrates.

FIG. 14 is a side sectional view of an environmental barrier seal according to one embodiment of the present invention prior to affixation to the article of the present invention. Environmental barrier seal or sealing tape 922, 1022, 1122, 1222, 1322 is illustrated in its affixed form in FIGS. 9, 10, 11, 12, and 13 respectively. We will now discuss Environmental barrier seal or sealing tape 1422 in a generic form that may be employed with any of the embodiments illustrated throughout this application. Sealing tape 1422 comprises a plurality of layers, including an inner layer 1424, an outer layer 1428, and an intermediate layer 1426 positioned between inner layer 1424 and outer layer 1428. Usually, environmental barrier seal 1422 provides effective protection again environment degradants at temperatures of about 38° C. or higher, typically about 60° C. or higher, more typically about 80° C. or higher, at a relative humidity of about 90% or greater, more typically about 95% or greater, and for time periods of about 200 hours or greater, more typically about 1000 hours or greater. The thickness of environmental barrier seal 1422 typically depends upon the bulk or stock material (e.g., foil barrier laminate material) that the seal is formed from. Usually, environmental barrier seal 1422 has a thickness of up to about 10 mils (254 microns) or less, and typically in the range of from about 3 to about 10 mils (from about 76 to about 254 microns), more typically from about 4 to about 5 mm (from about 102 to about 127 microns).

In an embodiment, inner layer 1422 comprises a thermally meltable adhesive to affix inner layer 1422 to the substrates of the present invention. In an embodiment of the invention, inner layer 1422 is an inner LLDPE thermally meltable adhesive layer having a nominal thickness equivalent of about 40 lbs. per 3000 ft² sheet. In an embodiment of the invention, inner layer 1422 comprises a thermoplastic film. It should be appreciated that in FIG. 14, inner layer 1424 is illustrated as extending the entire length of middle layer 1426, this is merely for illustrative purposes. Layer 1424 may be any length in relation to layers 1426, 1428 and 1430. The inner layer 1422 is adhered to peripheral edges substrates by heat sealing at a temperature of 180° C. (±5° C.) using a heat sealing apparatus as taught by Whiteside et al. '744 patent.

In an embodiment, intermediate layer 1426 comprises a moisture and oxygen impervious metallic foil having a minimum thickness of 0.35 mils (8.9 microns). Layer 1426 may be any length in relation to layers 1424, 1428 and 1430. In an embodiment of the invention, the metallic foil is aluminum foil.

In an embodiment, outer layer 1428 comprises a moisture impervious polyester (i.e., PET) outer layer having a nominal thickness equivalent of 48 gauge. In an embodiment, outer layer 1428 comprises one or more of: polyesters, copolyesters, polypropylene, polytetrafluoroethylene, nylon, polystyrene, a polycarbonate, an acrylonitrile, polyvinyl chloride, polyvinyl dichloride, ethylene vinyl alcohol, polyvinylidene chloride, ionomer-based polymers, and polyethylene. Layer 1428 may be any length in relation to layers 1424, 1426 and 1430.

In an embodiment, environmental barrier seal 1422 further comprises a tie layer 1430 positioned between outer layer 1428 and intermediate layer 1426 that adheres outer layer 1428 to intermediate layer 1426. In an embodiment, tie layer 1430 is polyethylene and has a nominal thickness equivalent of about 14 lbs. per 3000 ft² sheet. Layer 1430 may be any length in relation to layers 1424, 1426 and 1428.

Another embodiment of the present invention involves choosing materials for the substrates, holographic storage medium, and environmental barrier seals which have matching or compatible coefficients of thermal expansion. The results confirmed that if the entire media package is to expand the amount then there would not be any residual stress in the sealing tape to induce a change in the pitch error. In the alternative, a coefficient of thermal expansion (CTE) compensating interface is positioned between the holographic recording medium and at least one of the substrates to reduce the difference between the coefficients of expansion between the media and the substrate.

### Description of Holographic Storage Medium

The holographic storage medium (for example, as a holographic storage medium layer, film, sheet, etc.) useful in embodiments of the present invention may be formed such that holographic writing to and reading from the medium are possible. In at least some embodiments, fabrication of the holographic storage medium involves depositing a combination, blend, mixture, etc., of the support matrix/polymerizable component/photoinitiator component on a support structure, such as a pair of (i.e., two) substrates, and using, for example, a gasket to contain the mixture. It is possible to use spacers between the substrates to maintain a desired thickness for the recording medium. In applications requiring optical flatness, the liquid mixture may shrink during cooling (if a thermoplastic) or curing (if a thermoset) and thus distort the optical flatness of the article. To reduce such effects, it is useful to place the holographic storage medium between substrates in an apparatus containing mounts, e.g., vacuum chucks, capable of being adjusted in response to changes in parallelism and/or spacing. In such an apparatus, it is possible to monitor the parallelism in real-time by use of conventional interferometric methods, and to make any necessary adjustments to the heating/cooling process. During formation, the holographic storage medium may be supported in other ways other than by use of a substrate or substrates. More conventional polymer processing is also envisioned, e.g., closed mold formation or sheet extrusion. A stratified article is also contemplated, i.e., a plurality of holographic storage medium layers disposed between respective substrates.

In one embodiment of a holographic storage medium, it is possible to use conventional molding techniques to mold the combination, blend, mixture, etc., of the support matrix/polymerizable component/photoinitiator component into a variety of shapes prior to formation of the article by cooling to room temperature. For example, the combination, blend, mixture, etc., of the support matrix/polymerizable component/photoinitiator component can be molded into ridge waveguides, wherein a plurality of refractive index patterns are then written into the molded structures. It is thereby possible to easily form structures such as Bragg gratings. This feature increases the breadth of applications in which such polymeric waveguides would be useful.

In another embodiment of a holographic storage medium, the support matrix may be thermoplastic and allow the holographic storage medium to behave as if it is entirely a thermoplastic. That is, the support matrix allows the holographic storage medium to be processed similar to the way that a thermoplastic is processed, i.e., molded into a shaped form, blown into a film, deposited in liquid form between a pair of substrates, extruded, rolled, pressed, made into a sheet of material, etc., and then allowed to harden at room temperature to take on a stable shape or form. The support matrix may comprise one or more thermoplastics. Suitable thermoplastics include poly(methyl vinyl ether-alt-maleic anhydride), poly(vinyl acetate), poly(styrene), poly(ethylene), poly(propylene), poly(ethylene oxide), linear nylons, linear polyesters, linear polycarbonates, linear polyurethanes, poly(vinyl chloride), poly(vinyl alcohol-co-vinyl acetate).

In another embodiment, the amount of thermoplastic used in the holographic storage medium may be enough that the entire holographic storage medium effectively acts as a thermoplastic for most processing purposes. The binder component of the holographic storage medium may make up as much as about 5%, preferably as much as about 50%, and more preferably as much as about 90% of the holographic storage medium by weight. The amount of any given support matrix in the holographic storage medium may vary based on clarity, refractive index, melting temperature, T_{g}, color, birefringence, solubility, etc. of the thermoplastic or thermoplastics that make up the binder component. Additionally, the amount of the support matrix in the holographic storage medium may vary based on the article's final form, whether it is a solid, a flexible film, or an adhesive.

In another embodiment of the holographic storage medium, the support matrix may include a telechelic thermoplastic resin—meaning that the thermoplastic polymer may be functionalized with reactive groups that covalently crosslink the thermoplastic in the support matrix with the polymer formed from the polymerizable component during hologram formation. Such crosslinking makes the holograms stored in the thermoplastic holographic storage medium very stable, even to elevated temperatures for extended periods of time.

Similarly, in another embodiment of the holographic storage medium wherein a thermoset is formed, the matrix may contain functional groups that copolymerize or otherwise covalently bond with the monomer used to form the photopolymer. Such matrix attachment methods allow for increased archival life of the recorded holograms. Suitable thermoset systems for used herein are disclosed in to U.S. Pat. No. 6,482,551 (Dhar et al.), issued Nov. 19, 2002, the entire contents and disclosure of which are incorporated herein by reference.

In another embodiment of the holographic storage medium, the thermoplastic support matrix may be crosslinked noncovalently with the polymer formed upon hologram formation by using a functionalized thermoplastic polymer in the support matrix. Examples of such non-covalent bonding include ionic bonding, hydrogen bonding, dipole-dipole bonding, aromatic pi stacking, etc.

In another embodiment, the holographic storage medium comprises a polymerizable component that includes at least one photoactive polymerizable material that can form holograms made of a polymer or co-polymer when exposed to a photoinitiating light source, such as a laser beam that is recording data pages to the holographic storage medium. The photoactive polymerizable materials may include any monomer, oligomer, etc., that is capable of undergoing photoinitiated polymerization, and which, in combination with the support matrix, meets the compatibility requirements of the present invention. Suitable photoactive polymerizable materials include those which polymerize by a free-radical reaction, e.g., molecules containing ethylenic unsaturation such as acrylates, methacrylates, acrylamides, methacrylamides, styrene, substituted styrenes, vinyl naphthalene, substituted vinyl naphthalenes, other vinyl derivatives, etc. Free-radical copolymerizable pair systems such as vinyl ether/maleimide, vinyl ether/thiol, acrylate/thiol, vinyl ether/hydroxy, etc., are also suitable. It is also possible to use cationically polymerizable systems; a few examples are vinyl ethers, alkenyl ethers, allene ethers, ketene acetals, epoxides, etc. Furthermore, anionic polymerizable systems are also suitable herein. It is also possible for a single photoactive polymerizable molecule to contain more than one polymerizable functional group. Other suitable photoactive polymerizable materials include cyclic disulfides and cyclic esters. Oligomers that may be included in the polymerizable component to form a holographic grating upon exposure to a photoinitiating light source include oligomers such as oligomeric (ethylene sulfide) dithiol, oligomeric (phenylene sulfide) dithiol, oligomeric (bisphenol A), oligomeric (bisphenol A) diacrylate, oligomeric polyethylene with pendent vinyl ether groups, etc. The photoactive polymerizable material of the polymerizable component of holographic storage medium may be monofunctional, difunctional, and/or multifunctional.

In addition to the at least one photoactive polymerizable material, the holographic storage medium may contain a photoinitiator. The photoinitiator, upon exposure to relatively low levels of the recording light, chemically initiates the polymerization of the at least one photoactive polymerizable material, thus avoiding the need for direct light-induced polymerization. The photoinitiator generally should offer a source of species that initiate polymerization of the particular photoactive polymerizable material, e.g., photoactive monomer. Typically, from about 0.1 to about 20 vol. % photoinitiator provides desirable results.

A variety of photoinitiators known to those skilled in the art and available commercially are suitable for use in the holographic storage medium. It is advantageous to use a photoinitiator that is sensitive to light at wavelengths available from conventional laser sources, e.g. the blue and green lines of Ar⁺ (458, 488, 514 nm) and He—Cd lasers (442 nm), the green line of frequency doubled YAG lasers (532 nm), and the red lines of He—Ne (633 nm), Kr⁺ lasers (647 and 676 nm), and various diode lasers (290 to 900 nm). One advantageous free radical photoinitiator is bis(η-5-2,4-cyclopentadien-1-yl)bis[2,6-difluoro-3-(1H-pyrrol-1-yl)phenyl]titanium, available commercially from Ciba as Irgacure 784™. Another visible free-radical photoinitiator (which requires a co-initiator) is 5,7-diiodo-3-butoxy-6-fluorone, commercially available from Spectra Group Limited as H-Nu 470. Free-radical photoinitiators of dye-hydrogen donor systems are also possible. Examples of suitable dyes include eosin, rose bengal, erythrosine, and methylene blue, and suitable hydrogen donors include tertiary amines such as n-methyl diethanol amine. In the case of cationically polymerizable components, a cationic photoinitiator is used, such as a sulfonium salt or an iodonium salt. These cationic photoinitiator salts absorb predominantly in the UV portion of the spectrum, and are therefore typically sensitized with a sensitizer or dye to allow use of the visible portion of the spectrum. An example of an alternative visible cationic photoinitiator is (η₅-2,4-cyclopentadien-1-yl) (η₆-isopropylbenzene)-iron(II) hexafluorophosphate, available commercially from Ciba as Irgacure 261.

In many embodiments of the holographic storage medium, the photoinitiators used are sensitive to ultraviolet and visible radiation of from about 200 nm to about 800 nm.

The holographic storage medium may also include additives such as plasticizers for altering the properties thereof including the melting point, flexibility, toughness, diffusibility of the monomers, ease of processibility, etc. Examples of suitable plasticizers include dibutyl phthalate, poly(ethylene oxide) methyl ether, N,N-dimethylformamide, etc. Plasticizers differ from solvents in that solvents are typically evaporated whereas plasticizers are meant to remain in the holographic storage medium.

Other types of additives that may be used in the liquid mixture of the holographic storage medium are inert diffusing agents having relatively high or low refractive indices. Inert diffusing agents typically diffuse away from the hologram being formed, and can be of high or low refractive index but are typically low. Thus, when the monomer is of high refractive index, the inert diffusing agent would be of low refractive index, and ideally the inert diffusing agent diffuses to the nulls in an interference pattern. Overall, the contrast of the hologram is increased. Other additives that may be used in the liquid mixture of the holographic storage medium include: pigments, fillers, nonphotoinitiating dyes, antioxidants, bleaching agents, mold releasing agents, antifoaming agents, infrared/microwave absorbers, surfactants, adhesion promoters, etc.

In one embodiment of the holographic storage medium, the polymerizable component comprises less than about 20 volume %. In other embodiments, the polymerizable component of the holographic storage medium may be less than about 10 volume %, or even less than about 5 volume %. For data storage applications, the polymerizable component is typically present at about 5 volume %.

In one embodiment, the holographic storage medium may be used to store volatile holograms. Due to the ability to control the photopolymer chain length in the holographic storage medium, a particular mixture may be tuned to have a very general lifetime for the recorded holograms. Thus, after hologram recording, the holograms may be readable for a defined time period such as a week, a few months, or years. Heating the holographic storage medium may also increase such a process of hologram destruction. Examples of applications for using volatile holograms include: rental movies, security information, tickets (or season passes), thermal history detector, time stamp, and/or temporary personal records, etc.

In one embodiment, the holographic storage medium may be used to record permanent holograms. There are several methods to increase the permanency of recorded holograms. Many of these methods involve placing functional groups on the support matrix that allow for the attachment of photopolymer to the support matrix during cure. The attachment groups can be vinyl unsaturations, chain transfer sites, or even a polymerization retarder such as a BHT derivative. Otherwise, for increased archival stability of recorded holograms, a multifunctional monomer should be used which allows for crosslinking of the photopolymer, thus increasing the entanglement of the photopolymer in the support matrix. In one embodiment of holographic storage medium, both a multifunctional monomer and a support matrix-attached retarder are used. In this way, the shorter chains that are caused by the polymerization retarder do not cause loss of archival life.

In addition to the photopolymeric systems described above, various photopolymeric systems may be used in the holographic storage mediums of the present invention. For example, suitable photopolymeric systems for use herein are also described in: U.S. Pat. No. 6,103,454 (Dhar et al.), issued Aug. 15, 2000; U.S. Pat. No. 6,482,551 (Dhar et al.), issued Nov. 19, 2002; U.S. Pat. No. 6,650,447 (Curtis et al.), issued Nov. 18, 2003, U.S. Pat. No. 6,743,552 (Setthachayanon et al.), issued Jun. 1, 2004; U.S. Pat. No. 6,765,061 (Dhar et al.), Jul. 20, 2004; U.S. Pat. No. 6,780,546 (Trentler et al.), Aug. 24, 2004; U.S. Patent Application No. 2003-0206320, published Nov. 6, 2003, (Cole et al.), and U.S. Patent Application No. 2004-0027625, published Feb. 12, 2004, the entire contents and disclosures of which are herein incorporated by reference.

### Description of Articles

Embodiments of articles of the present invention may be of any thickness needed. For example the article may be thin for display holography or thick for data storage. For data storage applications, the article is typically from about 0.2 to about 2 mm, more typically from about 1 to about 1.5 mm in thickness, and is typically in the form of a film or sheet of holographic storage medium between two substrates with at least one of the substrates having an antireflective coating and may be sealed against moisture and air. An article of the present invention may also be made optically flat via the appropriate processes, such as the process described in U.S. Pat. No. 5,932,045 (Campbell et al.), issued Aug. 3, 1999, the entire contents and disclosure of which is herein incorporated by reference.

Embodiments of articles of the present invention may be used for decorative purposes. For example, the article may be used in gift wrap or in window treatments to provide special artistic tinting or 3D designs. The article may be used in molded parts of automobiles, toys, furniture, appliances, etc. to provide decorative effects. An article of the present invention may also be used to make data storage devices of various sizes and shapes, as a block of material or as part of a coating that is coated on a substrate.

### EXAMPLES

### Example 1

A disc-type article comprising: (1) a pair of upper and lower plates and each in the form of a circular-shaped piece of plastic; (2) a generally circular-shaped thermoplastic holographic storage medium positioned between upper and lower plates and; (3) a peripheral seal adhered to a peripheral edge of the upper plate 104, as well as the peripheral edge of the lower plate 144; (4) a generally circular-shaped upper central seal positioned over the upper portion of an upper central aperture extending beyond the perimeter of the upper central aperture and adhered to outside surface of the upper plate so as to seal off and enclose the upper central exposed area of the medium; and (5) a generally circular-shaped lower seal positioned over a lower central aperture of the lower plate with the lower central seal extending beyond the perimeter of the lower central aperture and adhered to the outside surface of the lower plate so as to seal off and enclose the lower central exposed area of the medium.

The peripheral seal comprises a PAKVF4 foil laminate film comprising, in order: (a) an inner LLDPE thermally meltable adhesive layer having a nominal thickness equivalent of about 40 lbs. per 3000 ft² sheet; (b) a moisture and oxygen impervious aluminum foil layer having a minimum thickness of 0.35 mils (8.9 microns); (c) a polyethylene tie layer having a nominal thickness equivalent of about 14 lbs. per 3000 ft² sheet; and (d) a moisture impervious polyester (i.e., PET) outer layer having a nominal thickness equivalent of 48 gauge. The foil laminate film is adhered to peripheral edges of the upper and lower plates by heat sealing at a temperature of 180° C. (±5° C.) using a heat sealing apparatus such as that shown in FIGS. 12-13 of the Whiteside et al. '744 patent.

The upper and lower central seals also comprise a PAKVF4 foil laminate film. The upper and lower central seals are adhered to respective outer surfaces of the upper plate lower plate using a jig wherein the press block is heated to a temperature of 180° C. (±5° C.) before insertion into bore 892 and pressing against a circular piece of PAKVF4 foil laminate film positioned over each of the upper and lower central apertures to adhere the film to respective outer surfaces of the upper plate and the lower plate.

All documents, patents, journal articles and other materials cited in the present application are hereby incorporated by reference.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom.

What is claimed is:

1. An article comprising:
a pair of substrates each comprising a thermoplastic and each having an outer edge;
a holographic storage medium positioned between the substrates such that the holographic storage medium has an exposed outer edge area proximate the outer edges of the substrates; and
an environmental barrier seal protecting the exposed outer edge area from environmental degradants;
wherein the environmental barrier seal comprises:
an inner layer adhered to at least one of the substrates and comprising a thermally meltable adhesive;
an outer layer comprising a moisture impervious material;
an intermediate layer positioned between the inner and outer layers and comprising a moisture and oxygen impervious material; and
an edge covering portion which covers the exposed outer edge area of the holographic storage medium and the outer edges of the substrates, wherein the edge covering portion includes a temperature-responsive stress-relieving structure and wherein the edge covering portion is adhered to the outer edge of each of the substrates.

2. The article of claim 1, wherein the environmental barrier seal further comprises a tie layer positioned between the outer layer and the intermediate layer that adheres the outer layer to the intermediate layer.

3. The article of claim 1, wherein the intermediate layer comprises metallic foil.

4. The article of claim 3, wherein the metallic foil comprises aluminum foil.

5. The article of claim 1, wherein the moisture impervious material comprises one or more of: polyesters, copolyesters, polypropylene, polytetrafluoroethylene, nylon, polystyrene, a polycarbonate, an acrylonitrile, polyvinyl chloride, polyvinyl dichloride, ethylene vinyl alcohol, polyvinylidene chloride, ionomer-based polymers, and polyethylene.

6. The article of claim 1, wherein the thermally meltable adhesive comprises a thermoplastic film.

7. The article of claim 1, wherein each substrate and the holographic recording medium are generally circular-shaped.

8. The article of claim 1, wherein the article has a thickness of from about 0.2 to about 2 mm.

9. The article of claim 1, wherein a coefficient of thermal expansion (CTE) compensating interface is positioned between the holographic recording medium and at least one of the substrates.

10. The article of claim 1, wherein the environmental barrier seal has a thickness of from about 3 to about 10 mils.

11. An article comprising:
a pair of substrates each comprising a thermoplastic and each having an outer edge;
a holographic storage medium positioned between the substrates such that the holographic storage medium has an exposed outer edge area proximate the outer edges of the substrates; and
an environmental barrier seal protecting the exposed outer edge area from environmental degradants;
wherein the environmental barrier seal comprises:
an inner layer adhered to at least one of the substrates and comprising a thermally meltable adhesive;
an outer layer comprising a moisture impervious plastic; and
an intermediate layer positioned between the inner and outer layers and comprising a moisture and oxygen impervious metallic foil;
wherein a portion of the environmental barrier seal comprises a temperature-responsive stress-relieving structure to thereby relieve stresses in the environmental barrier seal which may be caused by temperature changes.

12. The article of claim 11, wherein the environmental barrier seal further comprises a tie layer positioned between the outer layer and the intermediate layer that adheres the outer layer to the intermediate layer.

13. The article of claim 11, wherein the metallic foil comprises aluminum foil.

14. The article of claim 11, wherein the moisture impervious plastic comprises one or more of: polyesters, copolyesters, polypropylene, polytetrafluoroethylene, nylon, polystyrene, a polycarbonate, an acrylonitrile, polyvinyl chloride, polyvinyl dichloride, ethylene vinyl alcohol, polyvinylidene chloride, ionomer-based polymers, and polyethylene.

15. The article of claim 11, wherein the thermally meltable adhesive comprises a thermoplastic film.

16. The article of claim 11, wherein each substrate and the holographic recording medium are generally circular-shaped.

17. The article of claim 11, wherein the article has a thickness of from about 0.2 to about 2 mm.

18. The article of claim 11, wherein a coefficient of thermal expansion (CTE) compensating interface is positioned between the holographic recording medium and at least one of the substrates.

19. The article of claim 11, wherein the environmental barrier seal has a thickness of from about 3 to about 10 mils.

20. A process comprising the following steps of:
(a) providing an article comprising:
a pair of substrates each comprising a thermoplastic and each having an outer edge;
a holographic storage medium positioned between the substrates such that the holographic storage medium has an exposed edge area; and
an environmental barrier seal to protect the edge exposed area from environmental degradants, wherein the environmental barrier seal comprises:
an inner layer adhered to at least one of the substrates and comprising a thermally meltable adhesive;
an outer layer comprising a moisture impervious plastic; and
an intermediate layer positioned between the inner and outer layers and comprising a moisture and oxygen impervious metallic foil; and
(b) forming in a portion of the environmental barrier seal a temperature-responsive stress-relieving structure to thereby relieve stresses in the environmental barrier seal which may be caused by temperature changes.

21. The process of claim 20, further comprising the following step:
(c) adhering the environmental barrier seal to the outer edge of each substrate.

22. An article comprising:
a pair of substrates each comprising a thermoplastic and each having an outer edge;
a holographic storage medium positioned between the substrates such that the holographic storage medium has an exposed outer edge area proximate the outer edges of the substrates; and
an environmental barrier seal protecting the exposed outer edge area from environmental degradants;
wherein the environmental barrier seal comprises:
an inner layer adhered to at least one of the substrates and comprising a thermally meltable adhesive;
an outer layer comprising a moisture impervious plastic; and
an intermediate layer positioned between the inner and outer layers and comprising a moisture and oxygen impervious metallic foil;
wherein the substrates, holographic storage medium, and environmental barrier seal comprise materials which have compatible coefficients of thermal expansion.

23. The article of claim 22, wherein the environmental barrier seal further comprises a tie layer positioned between the outer layer and the intermediate layer that adheres the outer layer to the intermediate layer.

24. The article of claim 22, wherein the metallic foil comprises aluminum foil.

25. The article of claim 22, wherein the moisture impervious plastic comprises one or more of: polyesters, copolyesters, polypropylene, polytetrafluoroethylene, nylon, polystyrene, a polycarbonate, an acrylonitrile, polyvinyl chloride, polyvinyl dichloride, ethylene vinyl alcohol, polyvinylidene chloride, ionomer-based polymers, and polyethylene.

26. The article of claim 22, wherein the thermally meltable adhesive comprises a thermoplastic film.

27. The article of claim 22, wherein each substrate and the holographic recording medium are generally circular-shaped.

28. The article of claim 22, wherein the article has a thickness of from about 0.2 to about 2 mm.

29. The article of claim 22, wherein a coefficient of thermal expansion (CTE) compensating interface is positioned between the holographic recording medium and at least one of the substrates.

30. The article of claim 22, wherein the environmental barrier seal has a thickness of from about 3 to about 10 mils.
